(19) United States
(12) Patent Application Publication
(10) Pub. No.: US 2025/0216049 A1
(43) Pub. Date: Jul. 3, 2025

(54) VEHICLE LAMP

(71) Applicant: KOITO MANUFACTURING CO., LTD., Tokyo (JP)

(72) Inventors: Asami SAKASHITA, Shizuoka-shi, Shizuoka (JP); Ryo EBINUMA, Shizuoka-shi, Shizuoka (JP); Keita SANO, Shizuoka-shi, Shizuoka (JP); Kohei TAKENAGA, Shizuoka-shi, Shizuoka (JP)

(73) Assignee: KOITO MANUFACTURING CO., LTD., Tokyo (JP)

(21) Appl. No.: 18/835,145

(22) PCT Filed: Jan. 24, 2023
(86) PCT No.: PCT/JP2023/002140

§ 371 Date: Aug. 1, 2024

(30) Foreign Application Priority Data
Feb. 16, 2022 (JP) 2022-021738
Jul. 20, 2022 (JP) 2022-115388
Oct. 11, 2022 (JP) 2022-163479

(51) Int. Cl. F21S 43/241

(52) U.S. Cl. CPC F21S 43/241

(57) ABSTRACT

Vehicle lamp including a light guide including a light guide portion that guides light emitted from a light source, and a plate-shaped emission portion that is continuous with an outer peripheral surface of the light guide. The width of the light guide portion in the same direction as the thickness direction of the emission portion is larger than a thickness of the emission portion. One end surface in the longitudinal direction of the light guide portion is formed as an incident surface to which the light emitted from the light source is incident. An outer end surface of the emission portion is formed as an emission surface from which the light guided by the light guide portion is emitted. A plurality of control surfaces for controlling the light guided by the light guide portion such that the light is directed toward the emission surface are formed in the emission portion.

### TECHNICAL FIELD

The present invention relates to a technical field of vehicle lamp having a light guide for guiding and emitting incident light.

### BACKGROUND ART

There is a type of vehicle lamp that guides light emitted from a light source through a light guide and emits the light from an emission surface of the light guide (for example, see Patent Literature 1).

The vehicle lamp described in Patent Literature 1 is provided with a round shaft-shaped light guide extending in a predetermined direction, and a first reflective element and a second reflective element are formed as two types of reflective elements on the outer peripheral surface thereof. Light that is incident from an incident surface and reflected by the first reflective element travels to a first emission site, and light that is incident from the incident surface and reflected by the second reflective element travels to a second emission site, so that the light is emitted from each of the first emission site and the second emission site.

Light is reflected by such two types of reflective elements and the light is emitted from different emission sites, whereby it is possible to irradiate a wide range with light with the light guide.

### CITATION LIST

### Patent Literature

[Patent Literature 1] Japanese Unexamined Patent Application Publication No. 2017-183143

### SUMMARY OF THE INVENTION

### Technical Problem

In recent years, there has been a tendency that vehicle lamp is made thinner in terms of the shape and design of vehicles, and it has been desired that a light emitting area from the vehicle lamp is also made narrower to be set to a horizontally elongated emission state. Furthermore, such an emission state that emission portions of thin lines are arranged side by side in contiguity with one another has also been desired.

Such a narrowed emission state, etc. can be implemented by reducing the diameter of the light guide when a round shaft-shaped light guide as described in Patent Literature 1 is used.

However, when the diameter of the light guide is made smaller, the diameter of the incident surface is also made smaller by a corresponding amount, so that the incidence amount of light emitted from the light source to the light guide is reduced, resulting in decrease of light utilization efficiency.

Therefore, vehicle lamp according to the present invention has an object to implement a narrowed emission state while improving light utilization efficiency.

### Solution to Problem

Vehicle lamp according to the present invention includes a light guide including a light guide portion that extends in a predetermined direction and guides light emitted from a light source, and a plate-shaped emission portion that is continuous with an outer peripheral surface of the light guide portion, wherein the width of the light guide portion in the same direction as a thickness direction of the emission portion is set to be larger than the thickness of the emission portion, one end surface in a longitudinal direction of the light guide portion is formed as an incident surface to which the light emitted from the light source is incident, an outer end surface of the emission portion is formed as an emission surface from which the light guided by the light guide portion is emitted, and a plurality of control surfaces for controlling the light guided by the light guide portion such that the light is directed toward the emission surface is formed in the emission portion.

As a result, the light guided by the light guide portion whose width is set to be larger than the thickness of the emission portion is controlled by the plurality of control surfaces in the emission portion, and is emitted from the emission surface of the emission portion.

### Advantageous Effect of Invention

According to the present invention, the light guided by the light guide portion whose width is set to be larger than the thickness of the light emission portion is controlled by the plurality of control surfaces in the emission portion and emitted from the emission surface of the emission portion, so that the incidence amount of light emitted from the light source to the incident surface increases, which makes it possible to implement a narrowed light emission state while enhancing the light utilization efficiency.

### BRIEF DESCRIPTION OF THE DRAWINGS

FIG. 1 shows an embodiment of vehicular lighting equipment of the present invention together with FIGS. 2 to 23, and is a schematic sectional view of the vehicle lamp.

FIG. 2 is a sectional view of a light guide.

FIG. 3 is a plan view of the light guide.

FIG. 4 is a plan view of the light guide that shows an example in which an emission surface is curved when viewed from in an up-and-down direction.

FIG. 5 is a sectional view of the light guide that shows an example in which the emission surface is curved when viewed from a left-right direction.

FIG. 6 is a diagram showing an optical path in an example in which a control surface is formed in a triangular shape.

FIG. 7 is a diagram showing an optical path in an example in which the control surface is formed in a rectangular shape.

FIG. 8 is a sectional view showing an example in which a control hole is formed in an emission portion.

FIG. 9 is a diagram that conceptually shows an emission state.

FIG. 10 is a front view showing an example in which the light guide is bent.

FIG. 11 is a front view showing an example in which the light guide is curved.

FIG. 12 is a diagram showing an example in which the light guide is provided with two emission portions together with an optical path.

FIG. 13 is a diagram showing another example in which the light guide is provided with two emission portions together with an optical path.

FIG. 14 is a plan view showing a light guide according to a first modification.

FIG. 15 is a plan view showing a light guide according to a second modification.

FIG. 16 is a front view showing a light guide according to a third modification.

FIG. 17 is a sectional view showing the light guide according to the third modification.

FIG. 18 is a front view showing a light guide according to a fourth modification.

FIG. 19 is a sectional view showing the light guide according to the fourth modification.

FIG. 20 is a plan view showing a light guide according to a fifth modification.

FIG. 21 is a plan view showing a light guide according to a sixth modification.

FIG. 22 is a sectional view showing a light guide according to a seventh modification.

FIG. 23 is a sectional view showing a state when the light guide according to the seventh modification is formed.

### MODES FOR CARRYING OUT THE INVENTION

A mode for implementing vehicle lamp according to the present invention will be hereunder described with reference to the accompanying drawings.

Frontward, rearward, upward, downward, leftward, and rightward directions will be described hereunder with a radiation direction of light from the vehicle lamp being defined as a forward direction. However, the frontward, rearward, upward, downward, leftward, and rightward directions shown below are for the purpose of convenience of description, and the implementation of the present invention is not limited to these directions.

It is preferable that the vehicle lamp of the present invention is used as a clearance lamp, a turn signal lamp, or a daytime running lamp when it is attached to the front end side of a vehicle body, and it is preferable that the vehicle lamp is used as a tail lamp, a stop lamp, or a turn signal lamp when it is attached to the rear end side of the vehicle body. Further, the vehicle lamp of the present invention may be used as, for example, other vehicle lamp such as an indicating lamp, a room light, and illuminating lamp incorporated in a door handle during autonomous driving.

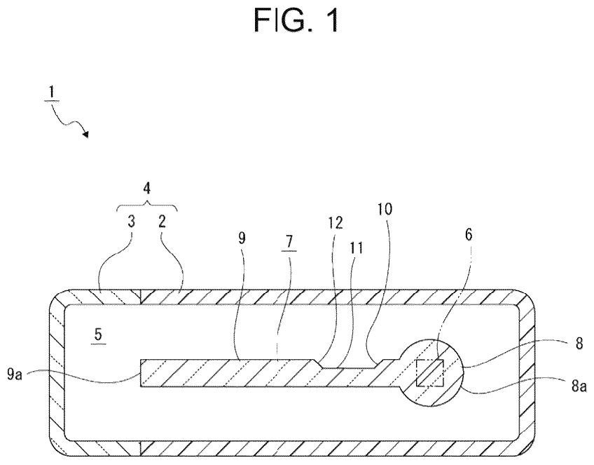

Vehicle lamp 1 includes a lamp housing 2 that is opened at the front or from the front to the side, and a cover 3 that closes the opening of the lamp housing 2 (see FIG. 1). The lamp housing 2 and the cover 3 constitute an outer casing 4 of the lighting equipment, and an internal space of the outer casing 4 of the lighting equipment is formed as a lighting chamber 5.

A light source 6 mounted on a board (not shown) and a light guide 7 for guiding light emitted from the light source 6 are arranged in the lighting chamber 5 (see FIGS. 1 to 3). Note that various members such as an extension may be arranged in the lighting chamber 5 in addition to the light source 6 and the light guide 7.

For example, a light emitting diode (LED) is used as the light source 6. The light source 6 is placed on a side of the light guide 7.

The light guide 7 is constituted by a light guide portion 8 extending in a predetermined direction, for example, a left-right direction, and a plate-shaped emission portion 9 that is continuous with an outer peripheral surface 8a of the light guide portion 8, and the light guide portion 8 and the emission portion 9 are integrally formed of transparent resin material or glass material.

The cross-sectional shape of the light guide portion 8 in a direction perpendicular to the longitudinal direction of the light guide portion 8 is formed as a circular shape, so that the light guide portion 8 is formed in the shape of a round shaft. The light guide portion 8 has a diameter of, for example, 4 mm or more. In the light guide portion 8, an end surface on the light source 6 side in the longitudinal direction is formed as an incident surface 8b, and the incident surface 8b is located so as to face the light source 6. Light emitted from the light source 6 is incident to the incident surface 8b. A step shape such as a reflective step is not formed on the light guide portion 8.

Note that the shape of the light guide portion 8 is not limited to a round-shaft shape, and the cross-sectional shape in the direction perpendicular to the longitudinal direction may be set to other shapes such as a rectangular shape or an elliptical shape.

However, the cross-sectional shape of the light guide portion 8 in the direction perpendicular to the longitudinal direction of the light guide portion 8 is formed to be a circular shape, so that the shape of the light guide portion 8 does not become an angular shape, and thus it is possible to increase the area of the light guide portion 8 without making the outer shape of the incident surface 8b large excessively. Therefore, it is possible to improve the light incidence efficiency while the light guide portion 8 is formed to have a simple shape.

Further, in a case where there is a probability that when light is guided by the light guide portion 8, light that is not incident from the light guide portion 8 to the emission portion 9 is emitted as leakage light, at least a part of the light guide portion 8 may be covered by an extension or the like, thereby preventing occurrence of leakage light.

The emission portion 9 is made continuous with a part of the outer peripheral surface 8a of the light guide portion 8. The emission portion 9 is formed in a flat-plate shape, for example, in a rectangular shape, and one long side thereof is made continuous with the outer peripheral surface 8a of the light guide portion 8. A thickness T of the emission portion 9 is set to be smaller than a width H of the light guide portion 8 in the up-and-down direction. Therefore, the width H of the light guide portion 8 in the same direction as the thickness direction of the emission portion 9 is set to be larger than the thickness T of the emission portion 9.

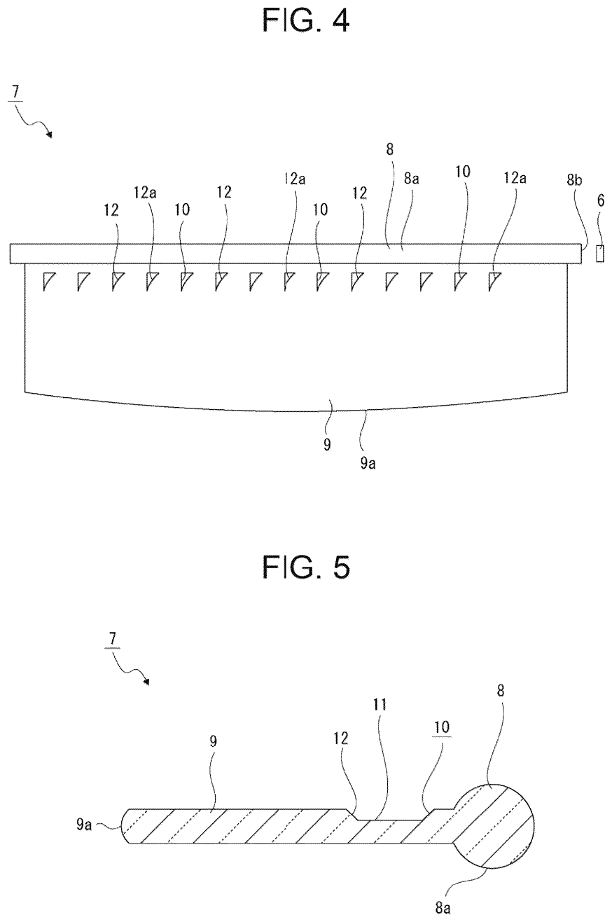

The outer end surface of the emission portion 9 is formed as, for example, a planar emission surface 9a facing forward. The width in the up-and-down direction of the emission surface 9a is set to, for example, about 2 mm to 3 mm, and light guided by the light guide portion 8 is emitted from the emission surface 9a. However, the emission surface 9a of the emission portion 9 may be formed to have a curved shape which is convex forward when viewed in the up-and-down direction (see FIG. 4), or may be formed to have a curved shape which is convex forward when viewed in the left-right direction (see FIG. 5). Further, the emission surface 9a of the emission portion 9 may be formed to have a curved shape which is concave forward when viewed in the up-and-down direction, or may be formed to have a curved shape which is concave forward when viewed in the left-right direction.

Note that a lens step may be formed on the emission surface 9a. By forming the lens step on the emission surface 9a, design performance when the emission surface 9a is viewed from the outside through the cover 3 is enhanced, which makes it possible to improve visibility. Further, by forming a lens step on the emission surface 9a or performing predetermined processing on the emission surface 9a, the vehicle lamp 1 can be configured such that light emitted from the emission surface 9a is emitted in a diffused state.

Further, in the vehicle lamp 1, by setting the emission portion 9 to be inclined with respect to the horizontal direction or the like, the upper surface or lower surface of the emission portion 9 and a control groove 10 formed in the emission portion 9 can be viewed through the cover 3 from the outside, whereby it is also possible to ensure design quality.

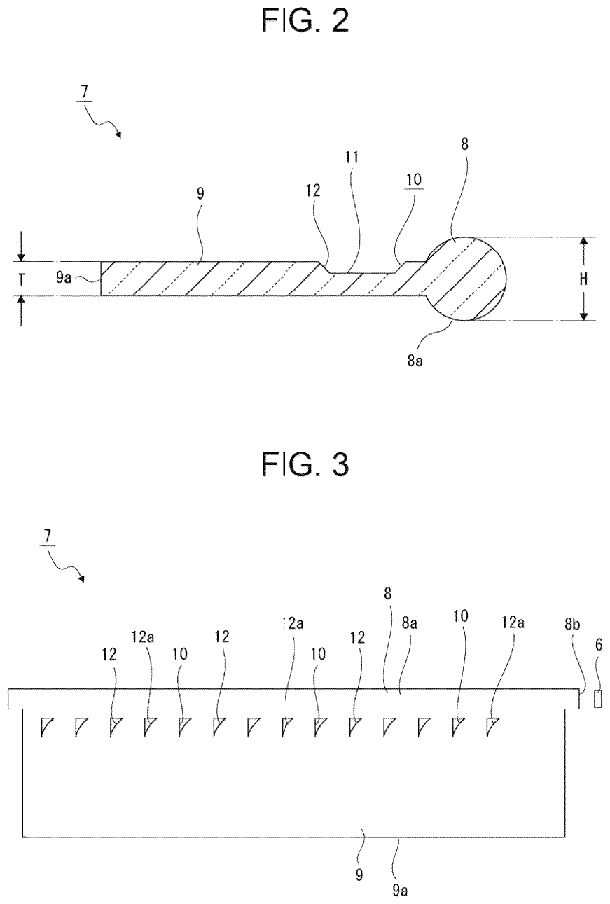

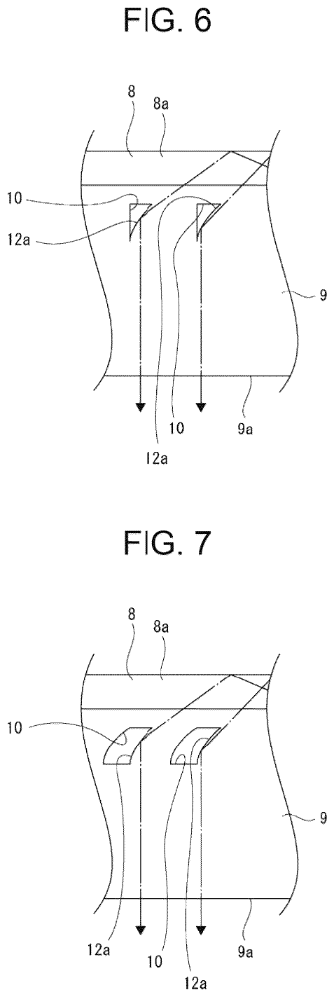

A plurality of control grooves 10 is formed in the emission portion 9 (see FIGS. 2, 3, and 6). The plurality of control grooves 10 is formed at positions close to the light guide portion 8, and is formed to be spaced apart from one another in the longitudinal direction of the light guide portion 8. The control grooves 10 are opened in the thickness direction of the emission portion 9, and for example, they are opened upward, but may be opened downward. The control grooves 10 are formed, for example, in a triangular shape when viewed in the up-and-down direction. However, the shape of the control grooves 10 is not limited to a triangular shape, and may be formed in other shapes such as a square shape (see FIG. 7). When the control grooves 10 are formed in a rectangular shape, the corners of the shape are unlikely to have acute angles, which makes it easy to process and makes it possible to form the control grooves 10 with high processing accuracy.

Note that the width of the emission portion 9 in the front-rear direction can be set to any size depending on the size of the lighting chamber 5 and the relation with other members arranged in the lighting chamber 5. For example, it is also possible to form a shape in which the width of the emission portion 9 in the front-rear direction changes in the longitudinal direction of the light guide portion 8.

The control groove 10 is formed by a bottom surface 11 facing upward and a peripheral surface 12 whose lower edge is continuous with the outer peripheral edge of the bottom surface 11, and one surface of the peripheral surface 12 is used as a control surface 12a. Further, the peripheral surface 12 is formed into an inclined surface which is slightly inclined to ensure a draught of a mold when the emission portion 9 is formed. The control surface 12a is a surface of the peripheral surface 12 that is located on the incident surface 8b side of the light guide portion 8, and it is inclined with respect to the longitudinal direction of the light guide portion 8, and formed into a curved surface, for example. The control surface 12a is inclined so as to be farther away from the incident surface 8b as it goes forward. The control surface 12a has a function of controlling light guided by the light guide portion 8, and the light which is guided by the light guide portion 8 and incident on the control surface 12a is totally reflected by the control surface 12a and travels to the emission surface 9a.

Note that the control surface 12a may be formed into a shape having a diffusing step instead of a curved shape or a planar shape. By forming the diffusing step on the control surface 12a, light emitted from the emission surface 9a is diffused, and uniformity of the light can be ensured.

As described above, the control grooves 10 opened in the thickness direction are formed in the emission portion 9, and parts of the peripheral surfaces 12 forming the control grooves 10 are used as the control surfaces 12a.

Therefore, since the control surfaces 12a are formed by forming grooves in the emission portion 9, the control surfaces 12a can be easily formed with high processing accuracy.

Note that the plurality of control grooves 10 may be formed to have the same size or different sizes. When the control grooves 10 are formed to have different sizes, the respective sizes of the control grooves 10 may be determined, for example, such that the areas of the control surfaces 12a increase as they are farther away from the emission surface 9a. Since the light guided by the light guide portion 8 attenuates as it is farther away from the emission surface 9a, such a configuration makes it possible to make the amount of light incident to all the control surfaces 12a constant, so that it is possible to achieve uniformity in the brightness of light emitted from the emission surface 9a.

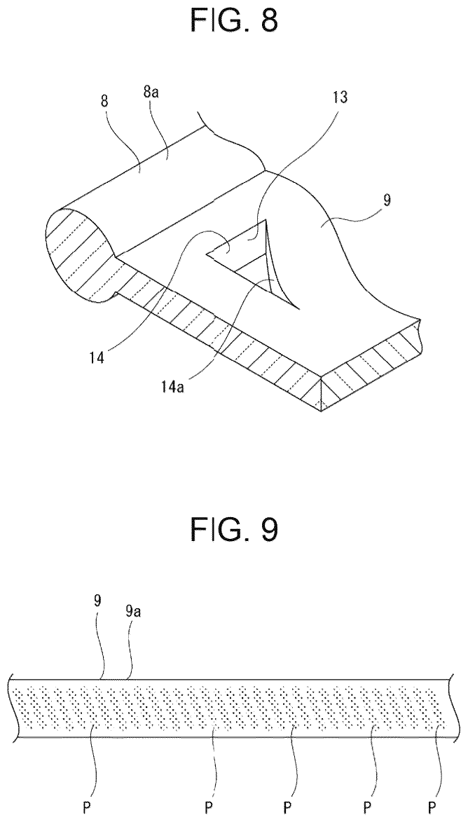

Moreover, although the example in which the control grooves 10 are formed in the emission portion 9 has been illustrated above, control holes 13 may be formed in the emission portion 9 instead of the control grooves 10 (see FIG. 8). The control hole 13 penetrates through the emission portion 9 in the thickness direction, and is formed by a peripheral surface 14. One surface of the peripheral surface 14 is used as a control surface 14a. The control surface 14a has a function of controlling light guided by the light guide portion 8, and light which is guided by the light guide portion 8 and incident to the control surface 14a is totally reflected by the control surface 14a and travels to the emission surface 9a.

In this way, the control hole 13 penetrating through the emission portion 9 in the thickness direction is formed, and a part of the peripheral surface 14 forming the control hole 13 is used as the control surface 14a, so that the control surface 14a is configured by forming a hole in the emission portion 9. Therefore, the area of the control surface 14a can be increased, and light control can be easily performed.

In the vehicle lamp 1 configured as described above, when light is emitted from the light source 6, the emitted light is incident from the incident surface 8b and guided through the light guide portion 8, and the light guided through the light guide portion 8 is incident to each of the plurality of control surfaces 12a. The light incident to the control surfaces 12a is totally reflected and controlled by the control surfaces 12a to travel to the emission surface 9a, and then emitted from the emission surface 9a, transmitted through the cover 3, and radiated to the outside.

At this time, the light is controlled by each control surface 12a, and each controlled light beam is visually recognized as a thin line of a light emitting portion from the emission surface 9a, thereby achieving such a light emitting state in which a plurality of light emitting portions P is arranged side by side in contiguity with one another (see FIG. 9). Further, since the emission surface 9a is formed in an elongated shape in the left-right direction, the light emitting state to be visually recognized through the cover 3 is visually recognized by viewers as one horizontally elongated line-shaped light emitting state in which the light emitting portions P are gathered.

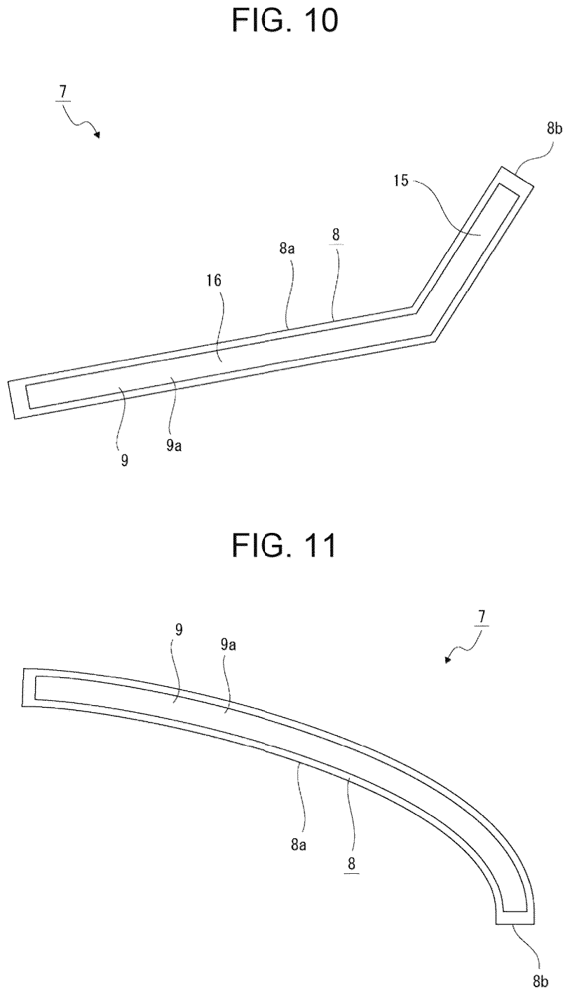

While the example in which the emission portion 9 is formed in a flat-plate shape facing in the up-and-down direction has been illustrated above, the emission portion 9 may be bent when viewed in the front-and-rear direction and may be constituted by a plurality of flat-plate-shaped portions (see FIG. 10). For example, the emission portion 9 may be constituted by a first portion 15 and a second portion 16 that are each formed into a flat-plate shape, and may be bent at the boundary between the first portion 15 and the second portion 16. In this case, the light guide portion 8 is also formed to have a shape which is bent in conformity with the first portion 15 and the second portion 16. Note that neither the first portion 15 nor the second portion 16 need be formed in a flat-plate shape, and at least one of them may be formed in a curved shape.

Moreover, the emission portion 9 may be formed in a curved shape as a whole when viewed in the front-and-rear direction (see FIG. 11). In this case, the light guide portion 8 is also formed in a curved shape in conformity with the emission portion 9.

The light guide portion 8 and the emission portion 9 are formed in a bent or curved shape in this way, so that the light guide portion 8 and the emission portion 9 can be formed into a shape that matches the overall shape of the vehicle body and the vehicle lamp 1, which makes it possible to miniaturize the vehicle lamp 1 due to an improvement in degree of freedom in design.

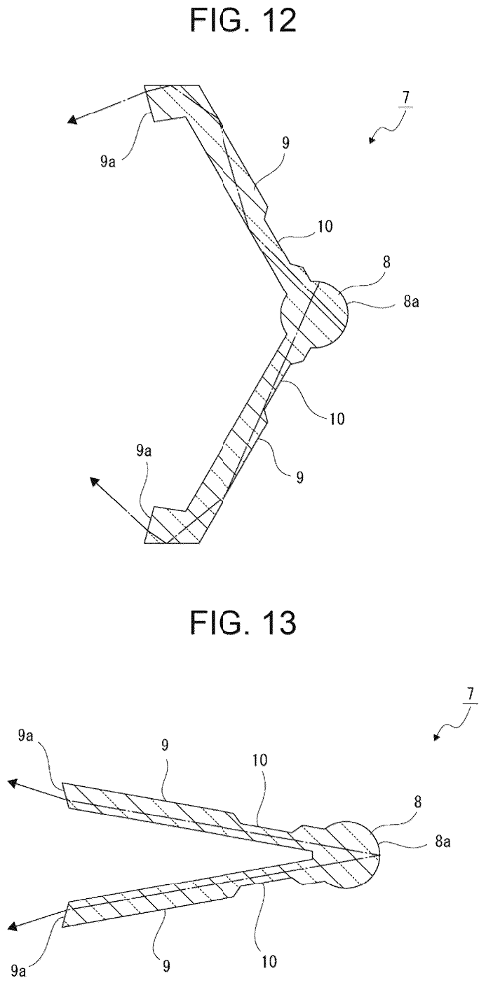

Further, the vehicle lamp 1 may be configured such that a plurality of continuous emission portions 9 is provided on different surfaces of the light guide portion 8 (see FIGS. 12 and 13). In this case, depending on the inclination angle of the emission portion 9 with respect to the horizontal direction, the emission portion 9 may be bent or curved such that the emission surface 9a faces forward when viewed in the left-right direction (see FIG. 13).

In such a configuration having the plurality of emission portions 9, light is emitted from each of the plurality of emission surfaces 9a, so that it is possible to improve the degree of freedom in design and the emission efficiency.

As described above, in the vehicle lamp 1, the width H of the light guide portion 8 in the same direction as the thickness direction of the emission portion 9 is set to be larger than the thickness T of the emission portion 9, and the plurality of control surfaces 12a, 14a for controlling the light guided through the light guide portion 8 such that the light travels to the emission surface 9a is formed in the emission portion 9.

Therefore, the light guided by the light guide portion 8 whose width is set to be larger than the thickness of the emission portion 9 is controlled by the plurality of control surfaces 12a, 14a of the emission portion 9, and emitted from the emission surface 9a of the emission portion 9. Therefore, the incident amount of light emitted from the light source 6 to the incident surface 8b increases, and it is possible to implement a narrowed light emission state while increasing the light utilization efficiency.

Further, in an example in which at least a part of the emission portion 9 is formed in a flat-plate shape, the emission portion 9 is formed in a simple shape, and also formed in a shape that makes it easy to control light, so that it is possible to easily perform control of light while the structure is simplified.

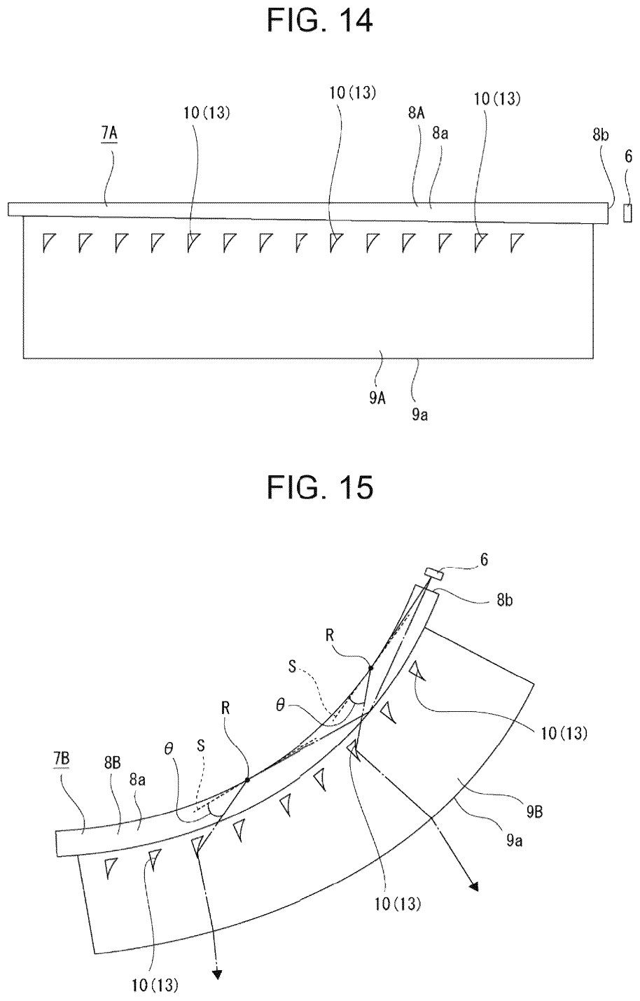

Each modification of the light guide will be described below (see FIGS. 14 to 23).

Since each modification of the light guide shown below has the same basic structure as that of the light guide 7 described above, different portions from the light guide 7 will be described while symbols such as A, B, etc. are appended to the respective signs.

A light guide 7A according to a first modification is constituted by a light guide portion 8A and an emission portion 9 (see FIG. 14).

The light guide portion 8A is formed in such a shape that the outer shape (diameter) is smaller as it is farther away from the incident surface 8b in the longitudinal direction. For example, when the thickness of the emission portion 9 is set to 2 mm, the diameter of one end of the light guide portion 8A on the light source 6 side is set to 6 mm, and the diameter of the other end thereof on an opposite side to the light source 6 is set to 4 mm.

The light guide portion 8A may be formed in a curved shape. In this case, the emission portion 9 may also be formed in a curved shape in conformity with the shape of the light guide portion 8A.

The light which is emitted from the light source 6 and incident from the incident surface 8b is totally reflected and incident to the emission portion 9, but the light is attenuated as it is farther away from the light source 6 in the light guide portion 8A. Further, light which is not incident to the emission portion 9, but is emitted from the light guide portion 8A and is not used as irradiation light in the vehicle lamp 1 also exists in the light which is incident from the incident surface 8b. However, the light guided by the light guide portion 8A is more easily incident to the emission portion 9 as the difference between the thickness of the emission portion 9 and the diameter of the light guide portion 8A is smaller.

Therefore, by using the light guide portion 8A whose outer shape is smaller as it is farther away from the incident surface 8b in the longitudinal direction as described above, the light which is incident from the incident surface 8b and is totally reflected is more easily incident to the emission portion 9, so that the incidence efficiency of light from the light guide portion 8A to the emission portion 9 is enhanced and the light utilization efficiency can be improved.

Further, although the example in which the light guide portion 8A is formed in such a shape that the outer shape is smaller as it is farther away from the incident surface 8b in the longitudinal direction has been illustrated above, the light guide portion 8A may be formed, for example, in such a shape that the outer shape is stepwise smaller as it is farther away from the incident surface 8b in the longitudinal direction. For example, the light guide portion 8A may be formed in a shape in which a portion having an outer diameter of 6 mm, a portion having an outer diameter of 5 mm, and a portion having an outer diameter of 4 mm are continuous with one another in the longitudinal direction.

A light guide 7B according to a second modification is constituted by a light guide portion 8B and an emission portion 9B (see FIG. 15).

The light guide portion 8B is formed in a curved shape as a whole when viewed in the up-and-down direction, and the emission portion 9B is also formed in a curved shape in conformity with the shape of the light guide portion 8B. The emission surface 9a of the emission portion 9B is formed in a curved-surface shape.

Since the light guide portion 8B and the emission portion 9B are formed in a curved shape, the light guide portion 8B and the emission portion 9B can be formed in a shape that matches the overall shape of the vehicle body and the vehicle lamp 1. Therefore, it is possible to miniaturize the vehicle lamp 1 by enhancing the degree of freedom in design.

In the light guide 7B, the light which is emitted from the light source 6 and incident from the incident surface 8b is totally reflected by the curved light guide portion 8B, incident to the emission portion 9B, and emitted from the emission surface 9a formed in a curved-surface shape. At this time, the light reflected at a reflection point R is reflected at a predetermined angle θ. The angle θ is an angle from a tangent S at the reflection point R, and for example, it is equal to about 30 degrees. Note that the angle θ changes depending on the curvature of the light guide portion 8B, but it is an angle close to 30 degrees regardless of the curvature.

Further, the light emitted from the emission surface 9a of the emission portion 9B is refracted when it is emitted from the emission surface 9a.

As described above, the light which is emitted from the light source 6 and guided by the light guide 7B is totally reflected by the light guide portion 8B, and controlled by the control grooves 10 or the control holes 13 to be refracted and emitted from the emission surface 9a of the emission portion 9B.

Therefore, the control surfaces 12a, 14a of the control grooves 10 or the control holes 13 are determined according to the angle 0 at which the light is totally reflected by the light guide portion 8B and the emission angle at which the light is emitted from the emission surface 9a, whereby it is possible to emit light in a desired direction from the emission surface 9a.

As described above, in the vehicle lamp 1, since it is possible to emit light in a desired direction by determining the control surfaces 12a, 14a according to the angle θ and the emission angle from the emission surface 9a, the emission direction of light can be easily adjusted.

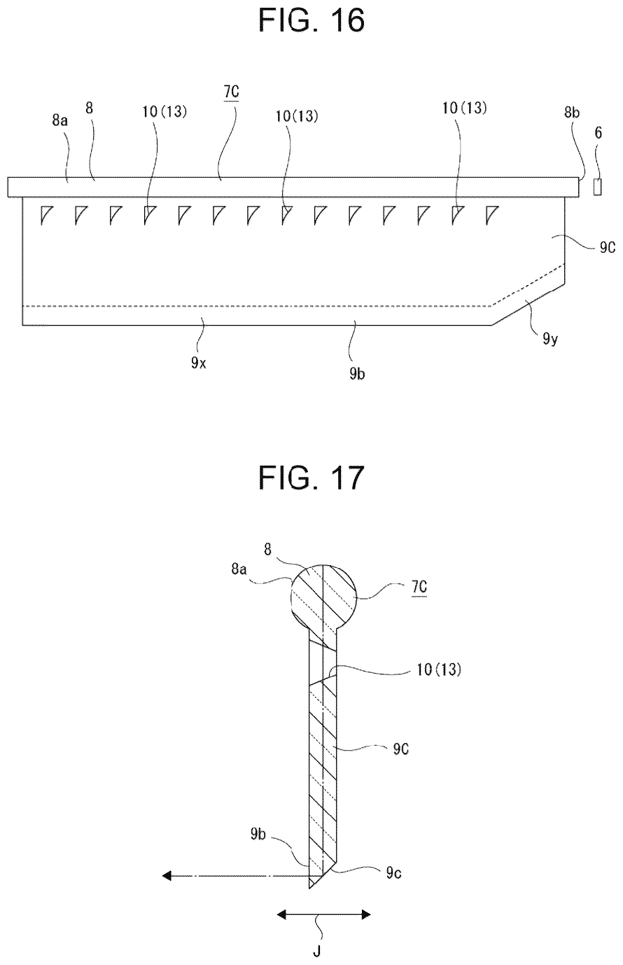

A light guide 7C according to a third modification is constituted by a light guide portion 8 and an emission portion 9C (see FIGS. 16 and 17).

In the light guide 7C, the light guide portion 8 and the emission portion 9C are located, for example, so as to be continuous with each other in the up-and-down direction, and the light guide portion 8 is located above the emission portion 9C.

The emission portion 9C is formed in a plate-like shape facing in the front-rear direction, and the front surface at a lower end portion thereof is formed as an emission surface 9b. A reflective surface 9c is formed on the rear side of the emission surface 9b in the emission portion 9C, and the reflective surface 9c is inclined at 45 degrees with respect to the emission surface 9b. The lower end of the reflective surface 9c is made continuous with the lower end of the emission surface 9b.

The lower edge of the emission portion 9C is inclined such that one end portion in the left-right direction is displaced upward with respect to the other portion. Therefore, the emission surface 9b and the reflective surface 9c are inclined such that respective parts thereof are displaced upward with respect to the other parts.

The emission surface 9b is constituted by a straight portion 9x extending in the left-right direction, and an inclined portion 9y which is inclined upward with respect to the straight portion 9x, and the inclined portion 9y is bent so as to be closer to the light guide portion 8 with respect to the straight portion 9x. As described above, the emission surface 9b has the inclined portion 9y, which makes it possible to emit light from a desired area which is set according to the overall shape of the vehicle body and the vehicle lamp 1, so that the degree of freedom in design can be enhanced and visibility can be improved.

In the light guide 7C, the light which is emitted from the light source 6 and incident from the incident surface 8b is totally reflected at the light guide portion 8, incident to the emission portion 9C, controlled by the control grooves 10 or control holes 13, totally reflected at the reflective surface 9c, and then emitted from the emission surface 9b.

The configuration having the emission surface 9b constituted by the straight portion 9x and the inclined portion 9y as described above can also be formed, for example, by bending a part of the light guide portion 8 and a part of the emission portion 9 upward in a configuration in which the emission portion 9 is continuous to the front side of the light guide portion 8 like the light guide 7.

However, in a case where the light guide 7 is formed by injection molding using a mold in the configuration in which a part of the light guide portion 8 and a part of the emission portion 9 are bent upward, if the opening-closing direction of two molds (a fixed mold and a movable mold) is set to the thickness direction of the emission portion 9, the opening direction of the control grooves 10 (control holes 13) would differ between an upward bent portion and an unbent portion of the emission portion 9. Therefore, other molds such as a slider are also required in the injection molding together with the two molds, which causes the manufacturing cost to rise.

On the other hand, when the emission surface 9b is constituted by the straight portion 9x and the inclined portion 9y by forming the reflective surface 9c as in the light guide 7C, the opening directions of all the control grooves 10 (control holes 13) can be set to the same direction. Therefore, it is possible to form the light guide 7C using two molds that are opened and closed in an opening and closing direction J in the injection molding.

Therefore, by using the light guide 7C, it is possible to enhance the degree of freedom in design and improve visibility by emitting light from a desired area set according to the overall shape of the vehicle body and the vehicle lamp 1 without increasing the manufacturing cost.

The foregoing description has been made on the example in which the straight portion 9x extending in the left-right direction and the inclined portion 9y inclined upward with respect to the straight portion 9x are formed with the light guide portion 8 being located above the emission portion 9C. Conversely, it is possible to modify the above configuration such that the straight portion 9x extending in the left-right direction and the inclined portion 9y inclined upward with respect to the straight portion 9x are formed with the light guide portion 8 being located below the emission portion 9C.

Moreover, the example in which the inclined portion 9y is inclined upward with respect to the straight portion 9x has been illustrated above, but the inclined portion 9y may be inclined downward with respect to the straight portion 9x.

When the light guide 7C is used, the portions other than the emission surface 9b may be covered from the front side by an extension to prevent leakage light from being emitted forward and to improve visibility when viewed from the outside.

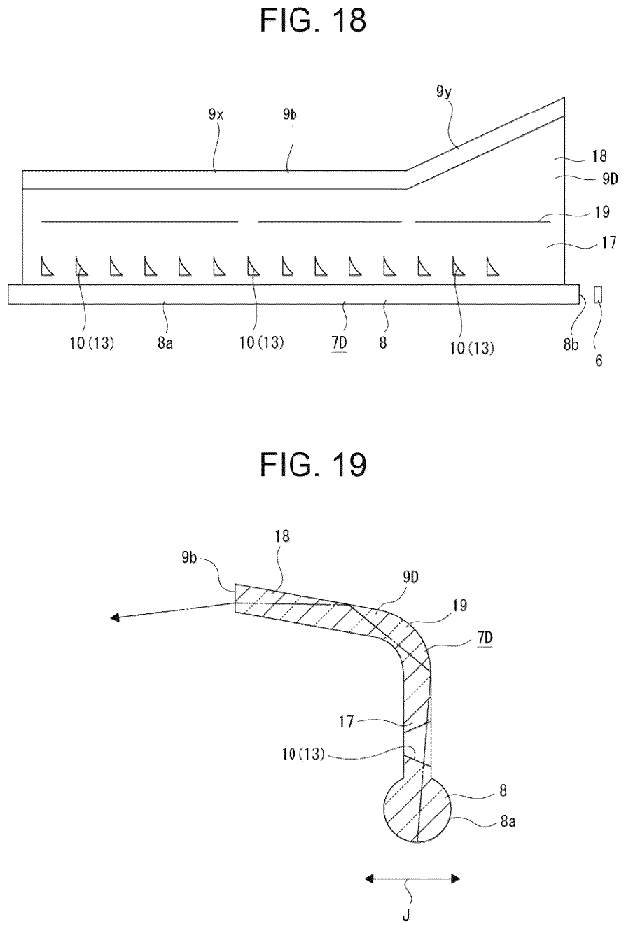

A light guide 7D according to a fourth modification is constituted by a light guide portion 8 and an emission portion 9D (see FIGS. 18 and 19).

In the light guide 7D, the light guide portion 8 and the emission portion 9D are arranged, for example, so as to be continuous with each other in the up-and-down direction, and the light guide portion 8 is located below the emission portion 9D.

The emission portion 9D is formed in a shape which is bent at a middle portion thereof in the up-and-down direction, and is constituted by a first portion 17 continuous with the light guide portion 8 and a second portion 18 continuous with the first portion 17. The first portion 17 is formed in a plate-like shape facing in the front-rear direction, and has the control grooves 10 or the control holes 13. The second portion 18 is formed in a plate-like shape facing substantially in the up-and-down direction, and has the emission surface 9b.

The second portion 18 is bent forward with respect to the first portion 17. Therefore, the second portion 18 is bent toward one side in the opening direction (front-rear direction) of the control grooves 10 or the control holes 13 with respect to the first portion 17.

A continuous portion 19 between the first portion 17 and the second portion 18 is formed in a curved shape.

The second portion 18 is inclined such that one end portion in the left-right direction is displaced upward with respect to the other portion. Therefore, the emission surface 9b is inclined such that a part thereof is displaced upward with respect to the other part.

The emission surface 9b is constituted by the straight portion 9x extending in the left-right direction, and the inclined portion 9y inclined upward with respect to the straight portion 9x, and the inclined portion 9y is bent so as to depart from the light guide portion 8 with respect to the straight portion 9x. The emission surface 9b has the inclined portion 9y as described above, which makes it possible to emit light from a desired area which is set according to the overall shape of the vehicle body and the vehicle lamp 1, whereby the degree of freedom in design can be enhanced and visibility can be improved.

In the light guide 7D, the light which is emitted from the light source 6 and incident from the incident surface 8b is totally reflected by the light guide portion 8, incident to the emission portion 9C, controlled by the control grooves 10 or the control holes 13, and emitted from the emission surface 9b.

As described in the description of the light guide 7C, the configuration having the emission surface 9b constituted by the straight portion 9x and the inclined portion 9y as described above can also be formed by bending a part of the light guide portion 8 and a part of the emission portion 9 upward. However, other molds such as a slider are required in addition to the two molds in the injection molding, which causes the manufacturing cost to rise.

On the other hand, when the emission surface 9b is constituted by the straight portion 9x and the inclined portion 9y by forming the reflective surface 9c as in the light guide 7D, the opening directions of all the control grooves 10 (the control holes 13) can be set to the same direction. Therefore, it is possible to form the light guide 7D using two molds that are opened and closed in the opening and closing direction J in the injection molding.

Accordingly, by using the light guide 7D, it is possible to enhance the degree of freedom in design and improve visibility by emitting light from a desired area set according to the overall shape of the vehicle body and the vehicle lamp 1 without increasing the manufacturing cost.

Further, since the continuous portion 19 of the emission portion 9D of the light guide 7D is formed in a curved shape, the light is easily totally reflected at the continuous portion 19, and the light controlled by the control grooves 10 or the control holes 13 easily reaches the emission surface 9b, so that the light emission efficiency can be improved.

The foregoing description has been made on the example in which the straight portion 9x extending in the left-right direction and the inclined portion 9y inclined upward with respect to the straight portion 9x are formed with the light guide portion 8 being located below the emission portion 9D. However, conversely, it is possible to modify the above configuration such that the straight portion 9x extending in the left-right direction and the inclined portion 9y inclined upward with respect to the straight portion 9x are formed with the light guide portion 8 being located above the emission portion 9D.

Furthermore, although the example in which the inclined portion 9y is inclined upward with respect to the straight portion 9x has been illustrated above, the inclined portion 9y may be inclined downward with respect to the straight portion 9x.

Further, when the light guide 7D is used, portions other than the second portion 18 are covered from the front side by an extension to prevent leakage light from being emitted forward and to improve visibility when viewed from the outside.

The example in which the emission surface 9b is constituted by the straight portion 9x and the inclined portion 9y is illustrated as examples of the light guide 7C and the light guide 7D. However, the emission surface 9b is not limited to the configuration having the inclined portion 9y, and for example, the emission surface 9b may be formed in a curved shape including an arc shape or the like, or in a shape including a linear shape and a curved shape which are continuous with each other. By forming the emission surface 9b in a shape including a curved shape, it is possible to enhance the degree of freedom in design and improve the visibility when viewed from the outside.

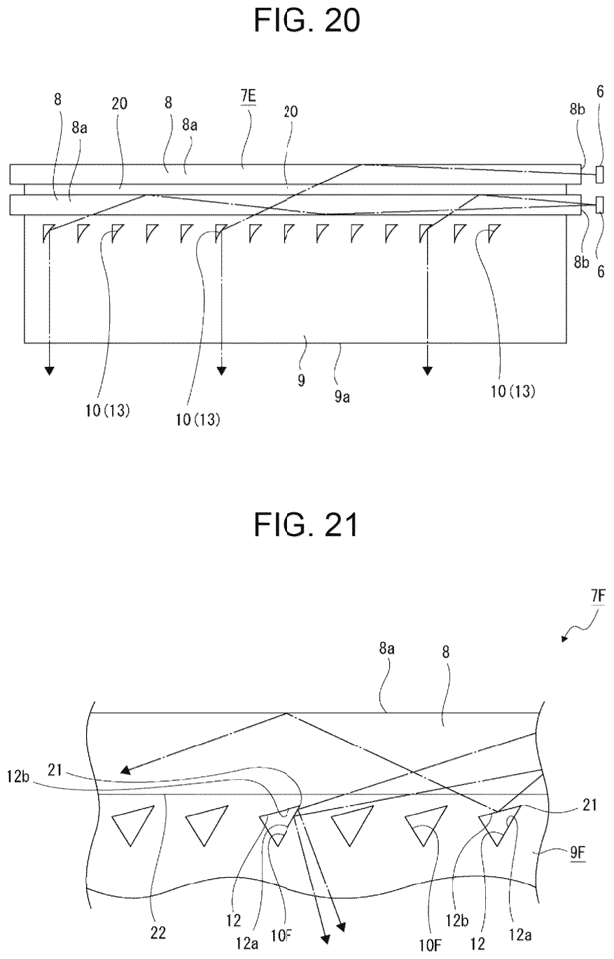

A light guide 7E according to a fifth modification has two light guide portions 8 and an emission portion 9 (see FIG. 20).

The two light guide portions 8 are arranged, for example, side by side in parallel to each other in the front-rear direction, and the outer peripheral surfaces 8a thereof are connected to each other by a connecting portion 20. The connecting portion 20 is formed in a flat-plate shape, and has a thickness smaller than the diameter of the light guide portion 8.

Light sources 6 are respectively arranged at positions facing the incident surfaces 8b of the two light guide portions 8. The two light sources 6 may emit light of the same color or may emit light of different colors.

In the light guide 7E, light which is emitted from one light source 6 and incident from the front-side incident surface 8b is totally reflected by the front-side light guide portion 8, controlled by the control grooves 10 or the control holes 13, incident to the emission portion 9, and then emitted from the emission surface 9a. Further, light which is emitted from the other light source 6 and incident from the rear incident surface 8b is totally reflected by the rear light guide portion 8, passed through the connecting portion 20 and the front light guide portion 8, controlled by the control grooves 10 or the control holes 13, incident to the emission portion 9, and then emitted from the emission surface 9a.

In such a configuration, as compared with a configuration in which only one light guide portion 8 is provided, and a plurality of light sources 6 is arranged so as to face the incident surface 8b, light can be easily made incident from each light source 6 to the light guide 7E and the efficiency of incidence of light to the light guide 7E can be improved.

In particular, in the configuration in which light of different colors is emitted from the respective light sources 6 while the colors are mixed with one another, and the mixed light is emitted from the emission surface 9a, the incidence efficiency of the light from each light source 6 is high, so that it is possible to surely emit desired mixed color light.

Further, although the example of the light guide 7E in which two light guide portions 8 are provided to be arranged side by side has been illustrated, the number of the light guide portions 8 in the light guide 7E may be three or more. In this case, each light source 6 is arranged so as to face the incident surface 8b of each light guide portion 8.

A light guide 7F according to a sixth modification includes a light guide portion 8 and an emission portion 9F (see FIG. 21).

Control grooves 10F are formed in the emission portion 9F. In the light guide 7F according to the sixth modification, control holes may be formed instead of the control grooves 10F.

The control groove 10F is formed, for example, in a triangular shape when

viewed from in the up-and-down direction. The peripheral surface 12 forming the control groove 10F is constituted by the control surface 12a and two other surfaces. The end of the control surface 12a on the light guide portion 8 side is formed as a light guide portion side end 21. A portion of the peripheral surface 12 forming the control groove 10F, which is continuous with the light guide portion side end 21 is formed as a continuous surface 12b.

The continuous surface 12b is located so as to be along a boundary surface 22 between the light guide portion 8 and the emission portion 9F, that is, a portion where the light guide portion 8 and the emission portion 9F are continuous with each other, and is inclined so as to be farther away from the boundary surface 22 as it goes in a light guide direction in the light guide portion 8 with respect to the boundary surface 22. The light guide direction is a direction from the incident surface 8b to an end surface on the opposite side in the longitudinal direction of the light guide portion 8. Therefore, the continuous surface 12b is inclined so as to be farther away from the boundary surface 22 in the longitudinal direction of the light guide portion 8 as it goes from the incident surface 8b to the end surface on the opposite side.

In the light guide 7F, light which is emitted from the light source 6 and incident on the incident surface 8b is guided by the light guide portion 8 to be incident to each of the plurality of control surfaces 12a. At this time, since the continuous surface 12b is inclined with respect to the boundary surface 22, light is easily made incident along the continuous surface 12b of one control groove 10F of adjacent control grooves 10F to the control surface 12a of the other control groove 10F.

Therefore, light which is nearly parallel to the boundary surface 22 is more easily made incident to the control surface 12a, and also the amount of light to be incident to the control surface 12a increases, so that the degree of diffusion of the light emitted from the emission surface 9a of the emission portion 9F is small, so that it is possible to improve the light utilization efficiency.

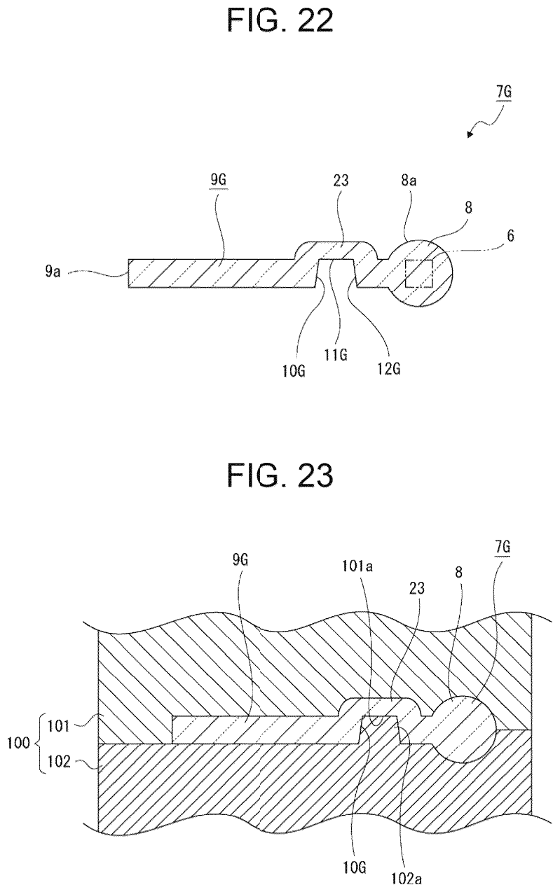

A light guide 7G according to a seventh modification is constituted by a light guide portion 8 and an emission portion 9G (see FIGS. 22 and 23).

A plurality of control grooves 10G are formed in the emission portion 9G. The control grooves 10G are opened in the thickness direction of the emission portion 9G, and for example, they are opened downward. However, they may be opened upward. The control groove 10G is formed by a bottom surface 11G facing downward and a peripheral surface 12G whose upper edge is continuous with the outer peripheral edge of the bottom surface 11G. The peripheral surface 12G is made as an inclined surface which is slightly inclined to ensure a draught of a mold 100 when the emission portion 9G is formed.

In the emission portion 9G, a bottom surface portion 23 including the bottom surface 11G forming the control groove 10G is formed in a convex shape on the opposite side to the opening side of the control groove 10G. Therefore, in the emission portion 9G in which the downwardly opened control groove 10G is formed, the bottom surface portion 23 is formed in an upwardly convex shape.

The light guide 7G is formed by injection molding using a mold 100, and

the mold 100 has a cavity mold 101 and a core mold 102 (see FIG. 23). In the mold 100, for example, the cavity mold 101 is located above the core mold 102, the cavity mold 101 has a molding recess portion 101a for forming the bottom surface portion 23, and the core mold 102 has a molding convex portion 102a for forming the control groove 10G. The molding convex portion 102a is formed into a tapered shape whose outer shape is smaller toward the tip thereof in order to ensure a draught.

The light guide 7G is formed by cooling molten resin filled in the cavity of the mold 100, and then opening the mold such that the cavity mold 101 and the core mold 102 are apart from each other. In a state where the cavity is formed by abutting the cavity mold 101 and the core mold 102, the outer end surface of the molding convex portion 102a is located apart from the cavity mold 101.

Therefore, since the molding convex portion 102a formed in a tapered shape does not come into contact with the cavity mold 101, it is possible to prevent damage or breakage of the molding convex portion 102a and the cavity mold 101, and also it is possible to ensure high molding accuracy of the light guide 7G.

In particular, even when the molding convex portion 102a is formed in a shape having an angular portion such as a truncated triangular pyramid shape or a quadrangular truncated pyramid shape, the molding convex portion 102a does not come into contact with the cavity mold 101, so that it is possible to prevent the angular portion of the molding convex portion 102a from being damaged or broken, thereby ensuring high molding accuracy of the light guide 7G.

Furthermore, in the light guide 7G, since the bottom surface portion 23 is formed in a convex shape, it is possible to increase the depth of the control grooves 10G, thereby increasing the amount of light incident to the control surfaces 12a, so that it is possible to improve the light utilization efficiency.

Furthermore, in the light guide 7G, since the bottom surface portion 23 is formed in a convex shape, the rigidity of the emission portion 9G can be improved by increasing the thickness of the bottom surface portion 23.

Even when the control grooves 10 are formed on the light guide 7 described above, since the molding convex portion for molding the control grooves 10 does not come into contact with the cavity mold, it is possible to prevent damage and breakage of the molding convex portion and the cavity mold, and also it is possible to ensure high molding accuracy of the light guide 7.

### REFERENCE SIGNS LIST

1 Vehicle lamp

6 Light source

7 Light guide

8 Light guide portion

8a Outer peripheral surface

8b Incident surface

9 Emission portion

9a Emission surface

10 Control groove

12 Peripheral surface

12a Control surface

13 Control hole

14 Peripheral surface

14a Control surface

7A Light guide

8A Light guide portion

9A Emission portion

7B Light guide

8B Light guide portion

9B Emission portion

7C Light guide

9C Emission portion

7D Light guide

9D Emission portion

17 First portion

18 Second portion

19 Continuous portion

7E Light guide

7F Light guide

9F Emission portion

10F Control groove

12b Continuous surface

20 Connecting portion

21 Light guide portion side end

7G Light guide

9G Emission portion

10G Control groove

11G Bottom surface

12G Peripheral surface

22 Boundary surface

23 Bottom surface portion

1. Vehicle lamp comprising a light guide including:
a light guide portion configured to extends in a predetermined direction and guide light emitted from a light source; and
a plate-shaped emission portion that is continuous with an outer peripheral surface of the light guide portion, wherein
a width of the light guide portion in same direction as a thickness direction of the emission portion is set to be larger than a thickness of the emission portion,
one end surface in a longitudinal direction of the light guide portion is formed as an incident surface to which the light emitted from the light source is incident,
an outer end surface of the emission portion is formed as an emission surface from which the light guided by the light guide portion is emitted, and
a plurality of control surfaces configured to controls the light guided by the light guide portion such that the light is directed toward the emission surface is formed in the emission portion.

2. The vehicle lamp according to claim 1, wherein
a control groove opened in the thickness direction is formed in the emission portion, and
a part of a peripheral surface forming the control groove is set as at least one of the control surfaces.

3. The vehicle lamp according to claim 1, wherein
a control hole penetrating in the thickness direction is formed in the emission portion, and
a part of a peripheral surface forming the control hole is set as at least one of the control surfaces.

4. The vehicle lamp according to claim 1, wherein a sectional shape in a direction perpendicular to the longitudinal direction of the light guide portion is formed in a circular shape.

5. The vehicle lamp according to claim 1, wherein at least a part of the emission portion is formed in a flat-plate shape.

6. The vehicle lamp according to claim 2, wherein
the emission portion includes a first portion in which the control groove opened in the thickness direction or a control hole penetrating in the thickness direction is formed in the emission portion, the first portion being continuous with the light guide portion, and a second portion on which the emission surface is formed, the second portion being continuous with the first portion,
a part of the second portion is bent so as to be farther away from or closer to the light guide portion with respect to the other part, and
the second portion is bent toward an opening direction side of the control groove or the control hole with respect to the first portion.

7. The vehicle lamp according to claim 6, wherein a continuous portion between the first portion and the second portion is formed in a curved shape.

8. The vehicle lamp according to claim 1, wherein
a control groove opened in the thickness direction or a control hole penetrating in the thickness direction is formed in the emission portion,
a part of a peripheral surface forming the control hole or the control groove is set as at least one of the control surfaces,
an end of at least one of the control surfaces on a light guide portion side is formed as a light guide portion side end,
a surface of the peripheral surface forming the control hole or the control groove, the surface being continuous with the light guide portion side end, is formed as a continuous surface,
the continuous surface is located so as to be along a boundary surface between the light guide portion and the emission portion, and
the continuous surface is inclined with respect to the boundary surface so as to be farther away from the boundary surface as the continuous surface goes in a light guiding direction of the light guide portion.

9. The vehicle lamp according to claim 2, wherein a bottom surface portion forming the control groove in the emission portion is formed in a convex shape on an opposite side to an opening side of the control groove.
